(19) United States
(12) Patent Application Publication
(10) Pub. No.: US 2005/0229322 A1
(43) Pub. Date: Oct. 20, 2005

(54) Ratcheting wrench with a detachable hammer

(75) Inventors: Light Chiu, Taichung Hsien (TW); Henry Chou, Taichung Hsien (TW)

Correspondence Address: OSTROLENK FABER GERB & SOFFEN, 1180 AVENUE OF THE AMERICAS, NEW YORK, NY, 100368403, US

(73) Assignee: Stanley Chiro International Ltd.

(21) Appl. No.: 10/825,983

(22) Filed: Apr. 16, 2004

(51) Int. Cl. B25F 1/00; B25B 13/46

(52) U.S. Cl. 7/138

(57) ABSTRACT

A ratcheting wrench includes a longitudinally extending handle body, a mounting seat disposed on an upper handle end of the handle body, a ratcheting fastening mechanism which includes a ratchet wheel assembly disposed in the mounting seat to rotate a drive shaft that extends outwardly from the mounting seat, and a hammer bell which is detachably coupled to the mounting seat and which extends transverse to the drive shaft such that the ratcheting wrench can perform ratcheting and hammering operations.

### BACKGROUND OF THE INVENTION

1. Field of the Invention

This invention relates to a ratcheting wrench, more particularly to a ratcheting wrench with a hammer bell detachably mounted on a mounted seat and angularly displaced from a ratcheting drive shaft for performing dual functions.

2. Description of the Related Art

Referring to FIG. 1, a conventional ratcheting wrench 1 is shown to include a handle body 11, a mounting seat 12 extending from an end of the handle body 11 for receiving a ratchet wheel assembly (not shown) therein, and a drive shaft 13 which extends outwardly from the mounting seat and which is coupled with the ratchet wheel assembly so as to be rotated therewith. Since the ratcheting wrench 1 only possesses a function to rotate tool bits, the operator generally prepares many hand tools for completing a work.

### SUMMARY OF THE INVENTION

The object of the present invention is to provide a ratcheting wrench which can perform both ratcheting and hammering operations.

According to this invention, the ratcheting wrench includes a handle body which extends in a longitudinal direction and which terminates at an upper handle end, a mounting seat which is disposed on the upper handle end, and which includes right and left walls opposite to each other in a first transverse direction relative to the longitudinal direction, and front and rear walls interposed between the right and left walls and opposite to each other in a second transverse direction relative to both the longitudinal direction and the first transverse direction, a ratcheting fastening mechanism which includes a ratchet wheel assembly that is disposed in the mounting seat between the right and left walls, and that is actuated to be rotated, and a drive shaft that extends outwardly from the front wall in the second transverse direction, and that is coupled with the ratchet wheel assembly to rotate with the ratchet wheel assembly, a hammer bell which has a hammer face end and an engaging end opposite to each other in the first transverse direction, and a coupling member which is disposed to detachably couple the engaging end with the left wall.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is a side schematic view of a conventional ratchet wrench;

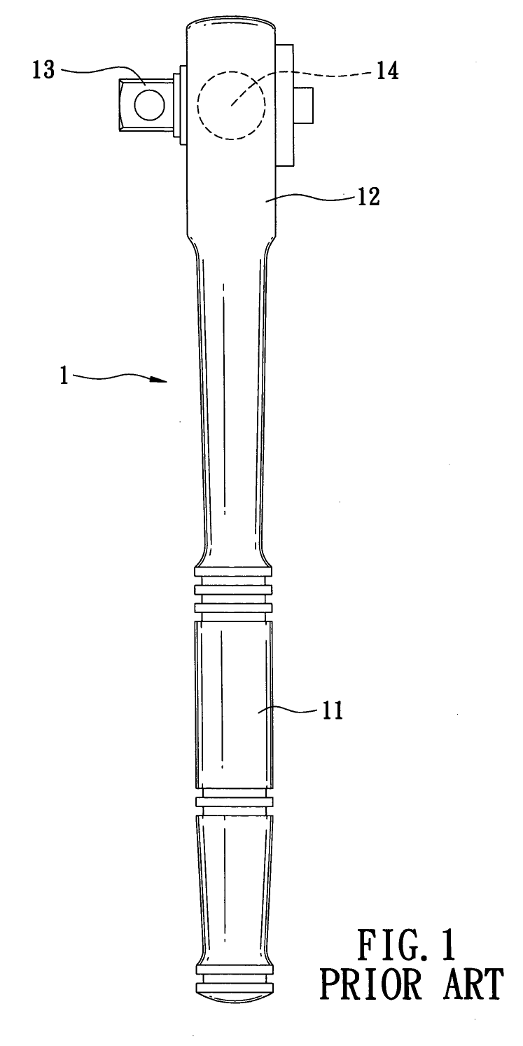

FIG. 2 is a perspective view of the preferred embodiment of a ratcheting wrench according to this invention with a hammer bell;

FIG. 3 is a side schematic view of the preferred embodiment shown in FIG. 2; and

FIG. 4 is a side schematic view of the preferred embodiment with two hammer bells.

### DETAILED DESCRIPTION OF THE PREFERRED EMBODIMENT

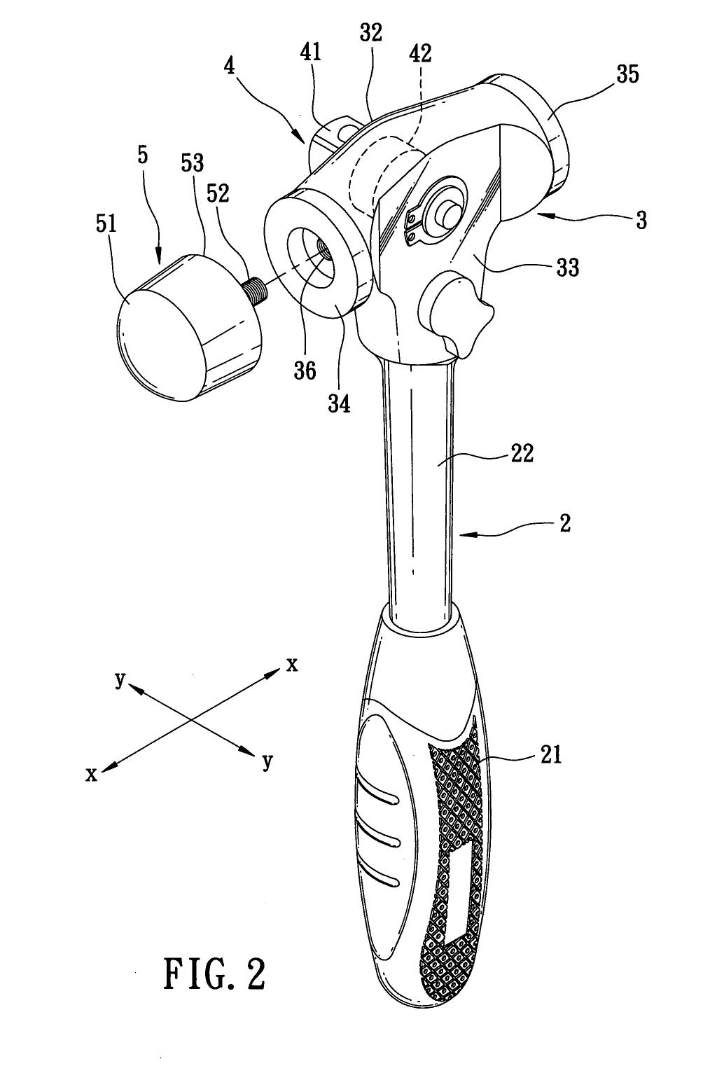

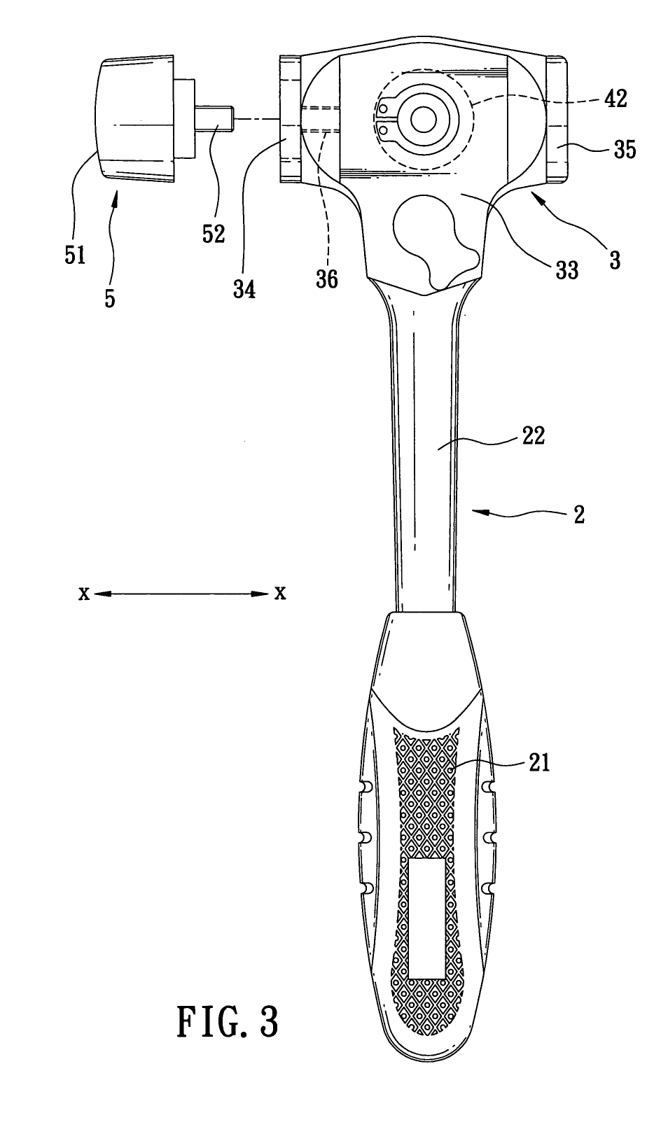

Referring to FIGS. 2 and 3, the preferred embodiment of a ratcheting wrench according to the present invention is shown to comprise a handle body 2, a mounting seat 3, a ratcheting fastening mechanism 4, a first hammer bell 5, and a first coupling member.

The handle body 2 includes a lower grip end 21 and an upper handle end 22 extending from the lower grip end 21 in a longitudinal direction. The mounting seat 3 is disposed on the upper handle end 22, and includes right and left walls 35,34 opposite to each other in a first transverse direction (x) relative to the longitudinal direction, and front and rear walls 32,33 interposed between the right and left walls 35,34 and opposite to each other in a second transverse direction (y) relative to both the longitudinal direction and the first transverse direction (x). The ratcheting fastening mechanism 4 includes a known ratchet wheel assembly 42 which is disposed in the mounting seat 3 between the right and left walls 35,34, and which is rotatable, and a drive shaft 41 which extends outwardly from the front wall 32 in the second transverse direction (y), and which is coupled with the ratchet wheel assembly 42 so as to rotate therewith.

The first hammer bell 5 is made from metal or rubber material, and has a first hammer face end 51 and a first engaging end 53 opposite to each other in the first transverse direction (x). The first coupling member includes a first threaded bore portion 36 which is formed in the left wall 34 and which has an internally threaded surface that extends in the first transverse direction (x), and a first threaded shank 52 which is disposed to extend from the first engaging end 53 in the first transverse direction (x) and which has an externally threaded surface that is threadedly engaged with the internally threaded surface of the first threaded bore portion 36 such that the first hammer bell 5 is detachably coupled to the mounting seat 3.

As illustrated, since the hammer bell 5 is disposed to extend transverse to the drive shaft 41, the ratcheting fastening mechanism 4 and the hammer bell 5 will not interfere with each other during fastening or hammering operation.

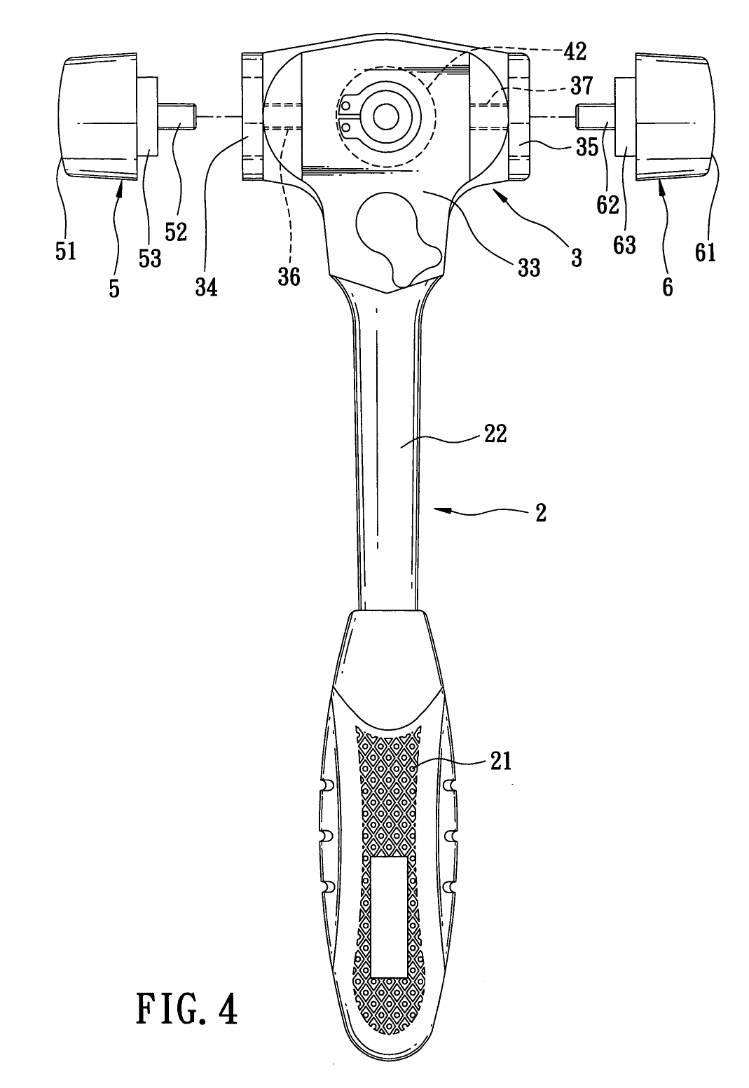

Furthermore, referring to FIG. 4, the ratcheting wrench of this invention may further comprise a second hammer bell 6 and a second coupling member. The second hammer bell 6 has a second hammer face end 61 and a second engaging end 63 opposite to each other in the first transverse direction. The second coupling member includes a second threaded bore portion 37 which is formed in the right wall and which has an internally threaded surface that extends in the first transverse direction (x), and a second threaded shank 62 which is disposed to extend from the second engaging end 63 in the first transverse direction (x) and which has an externally threaded surface that is threadedly engaged with the internally threaded surface of the second threaded bore portion 37 such that the second hammer bell 6 is detachably coupled to the mounting seat 3 opposite to the first hammer bell 5. As such, the first and second hammer bells 5,6 may be made from the same or different materials, such as metal and rubber.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

1. A ratcheting wrench comprising:
a handle body extending in a longitudinal direction, and terminating at an upper handle end;
a mounting seat disposed on said upper handle end, and including right and left walls opposite to each other in a first transverse direction relative to the longitudinal direction, and front and rear walls interposed between said right and left walls and opposite to each other in a second transverse direction relative to both the longitudinal direction and the first transverse direction;
a ratcheting fastening mechanism including a ratchet wheel assembly which is disposed in said mounting seat between said right and left walls, and which is rotatable, and a drive shaft which extends outwardly from said front wall in the second transverse direction, and which is coupled with said ratchet wheel assembly to rotate with said ratchet wheel assembly;
a first hammer bell having a first hammer face end and a first engaging end opposite to each other in the first transverse direction; and
a first coupling member disposed to detachably couple said first engaging end with said left wall.

2. A ratcheting wrench according to claim 1, wherein said first coupling member includes a first threaded bore portion which is formed in said left wall and which has an internally threaded surface that extends in the first transverse direction, and a first threaded shank which is disposed to extend from said first engaging end in the first transverse direction and which has an externally threaded surface that is threadedly engaged with said internally threaded surface.

3. A ratcheting wrench according to claim 1, wherein said first hammer face end is made from a metal material.

4. A ratcheting wrench according to claim 1, wherein said first hammer face end is made from a rubber material.

5. A ratcheting wrench according to claim 1, further comprising:
a second hammer bell having a second hammer face end and a second engaging end opposite to each other in the first transverse direction; and
a second coupling member disposed to detachably couple said engaging end with said right wall.

6. A ratcheting wrench according to claim 5, wherein said second coupling member includes a second threaded bore portion which is formed in said right wall and which has an internally threaded surface that extends in the first transverse direction, and a second threaded shank which is disposed to extend from said second engaging end in the first transverse direction and which has an externally threaded surface that is threadedly engaged with said internally threaded surface.

7. A ratcheting wrench according to claim 5, wherein said second hammer face end is made from a metal material.

8. A ratcheting wrench according to claim 5, wherein said second hammer face end is made from a rubber material.
